(19) United States
(12) Patent Application Publication
(10) Pub. No.: US 2014/0072253 A1
(43) Pub. Date: Mar. 13, 2014

(54) BEARING ARRANGEMENT WITH A BACK-UP BEARING, IN PARTICULAR FOR MOUNTING THE RAPIDLY ROTATING SHAFT OF A COMPRESSOR

(71) Applicant: Schaeffler Technologies AG & Co. KG, Herzogenaurach (DE)

(72) Inventors: Stefan Ruhl, Erlangen (DE); Jorg Bauer, Erlangen (DE); Peter Siebke, Erlangen (DE); Armin Bender, Herzogenaurach (DE); Mark Dudziak, Herzogenaurach (DE); Michael Pausch, Dittelbrunn (DE)

(21) Appl. No.: 14/116,849

(22) PCT Filed: Apr. 17, 2012
(86) PCT No.: PCT/EP2012/056954

§ 371 Date: Nov. 11, 2013

(30) Foreign Application Priority Data
May 12, 2011 (DE) 102011101307.9

(51) Int. Cl. F16C 33/58; F16C 19/18

(52) U.S. Cl. CPC F16C 33/583; F16C 19/18
USPC 384/495; 384/490; 384/513

(57) ABSTRACT

A bearing arrangement for the rotatable mounting of a shaft (7) in relation to a housing (8), including a back-up bearing (9) which is designed as a rolling contact bearing, wherein the rolling contact bearing can absorb forces in the axial and radial direction and is designed in particular as an angular rolling bearing, especially as a two-row angular ball bearing, wherein the rolling contact bearing (9) is substantially left open in the radial direction. The object addressed by the invention is that of providing a bearing arrangement with a back-up bearing for a shaft, which bearing arrangement can better absorb in particular the forces occurring in the mounting of rapidly rotating, solid shafts.

### FIELD OF THE INVENTION

The invention relates to a bearing arrangement having a back-up bearing, in particular as a component of the bearing of the rapidly rotating shaft of a compressor.

### BACKGROUND

Bearings are known in practice, wherein a shaft is supported rotatably in, for example, magnetic bearings. The bearing comprises a bearing arrangement having a back-up bearing, with the at least one back-up bearing receiving the shaft if the magnetic bearing fails. During normal operation of the at least one magnetic bearing, a back-up bearing gap is formed between the outer face of the shaft and an outer face of the inner bearing ring of the back-up bearing, which outer face is directed towards the shaft.

It is problematic to take up very rapidly rotating shafts having a great weight, for example to take up a solid shaft of a compressor rotating at up to approximately 6000 rpm, in a back-up bearing in the event of failure of the magnetic bearings of the bearing. In this instance, very high forces and moments which may damage the back-up bearing occur. Furthermore, during normal operation of the magnetic bearings of the bearing, the shaft falls eccentrically relative to the axis of rotation into the back-up bearing which is consequently subjected to an impact load occurring at the periphery in a non-uniform manner.

### SUMMARY

An object of the invention is to provide a bearing arrangement which has a back-up bearing for a shaft and which can better take up particularly the forces occurring when solid rapidly rotating shafts are received.

This object is achieved according to the invention by a bearing arrangement for rotatably supporting a shaft relative to a housing, comprising a back-up bearing which is in the form of a rolling bearing, with the rolling bearing being able to take up forces in an axial and radial direction and in particular being in the form of an angular rolling bearing, especially a two-row angular ball bearing, with the rolling bearing being substantially free in a radial direction.

As a result of the freedom of the rolling bearing in a radial direction in force terms, the rolling bearing preferably only takes up in an axial direction forces whose centering effect on the effect falling into the back-up bearing can be used. The rolling bearing is constructed in a radial direction substantially as a movable bearing.

There is preferably provision for there to be provided a bearing receiving member on which the outer ring of the rolling bearing is arranged, with the bearing receiving member having a peripheral material weakening, in particular two peripheral grooves. The peripheral material weakening reduces the absorption of forces in an axial direction only to a small extent but brings about a selectively produced resilience of radially acting forces.

There is preferably provision for a corrugated strip gap on the outer ring of the rolling bearing to be constructed so as to be radially enlarged. The width of the corrugated strip gap can be, for example, doubled or tripled in a selective manner. As a result of the substantially increased construction of the corrugated strip gap, the rolling bearing provided as a back-up bearing is deflected more powerfully in a radial direction if the shaft falls into the back-up bearing and transmits forces to a lesser extent in a radial direction than in an axial direction in a preferred manner. This applies both to the case that a corrugated strip is arranged in the corrugated strip gap and to the case that no corrugated strip is provided in the corrugated strip gap and the corrugated strip gap is therefore left free.

There is preferably provision for a corrugated strip having reduced rigidity, in particular having a reduced number of corrugations per section in the peripheral direction and/or having an increased corrugation amplitude, to be arranged on the outer ring of the rolling bearing. As a result of the reduced rigidity, the corrugated strip is very resilient with respect to radially occurring forces so that the back-up bearing takes up axial forces to a greater extent than radial forces.

There is preferably provision for the outer ring of the rolling bearing to be fixed to a first portion of a bearing receiving member, with a second portion of the bearing receiving member being arranged between the first portion of the bearing receiving member and the housing, and with the two portions of the bearing receiving member being resiliently supported on each other in a radial direction. The bearing receiving member is a component which is arranged between the back-up bearing and the fixed housing and which is constructed so as to be divided in two in a radial direction, with the two portions, that is to say, the first, radially inner portion in relation to the rotation axis of the shaft and the second, radially outer portion, being resiliently supported on each other. The resilient element between the two portions of the bearing receiving member takes up in particular forces in a radial direction so that the back-up bearing can take up and transmit the forces in particular in an axial direction.

There is preferably provision for the inner ring of the rolling bearing to form with the shaft a first friction face pair and for the outer ring of the rolling bearing to form, with an inner face of a bearing receiving member, a second friction face pair, with the friction properties of the two friction face pairs being adjusted for a friction-controlled self-centering action of the inner ring of the rolling bearing in relation to the shaft.

With regard to the construction of the two friction face pairs, there is preferably provision for the friction properties of the first friction face pair to be increased by means of coatings, linings, surface roughness or surface structures in relation to the friction properties of the second friction face pair.

With regard to the construction of the two friction face pairs, there is preferably further provision for the friction properties of the second friction face pair to be reduced by means of coatings or reduced surface roughness.

There is preferably provision for an end face of the inner ring of the rolling bearing to cooperate with a radially offset edge face on the shaft. In the region of the end face, in particular axial forces are introduced into the rolling bearing. The edge face and the end face form a guiding face pair which can be used by the shaft which falls into the back-up shaft to center the inner ring. In particular, the end face and the edge face may form a first friction face pair, whose friction properties can be adjusted selectively in order to make it easier to center the inner ring in a friction-controlled manner relative to the falling shaft. That is particularly possible even if both the end face of the inner ring and the edge face on the shaft are orientated substantially radially, that is to say, at an angle of approximately 90°, relative to the rotation axis of the shaft.

With regard to the edge face and the end face, there is preferably provision for the edge face and the end face to be formed so as to be at least partially inclined and to form a guiding face pair. As a result of the inclined construction, the centered orientation of the inner ring is supported in relation to the falling shaft.

With regard to the edge face and the end face, there is preferably provision for the edge face and the end face to define an angle relative to the rotation axis of the shaft, in particular a high angle of more than approximately 60°, specifically between approximately 75° and approximately 80°, relative to the rotation axis.

Alternatively, there is preferably provision for the edge face to partially define an angle of approximately 45° relative to the rotation axis, and with the end face having a rounded portion which cooperates with the inclined portion of the edge face. The end face of the inner ring is partially constructed so as to be, for example, of convex-toroidal form, with the convex-toroidal portion cooperating with the inclined portion of the edge face.

There is preferably provision for a resilient element to be arranged between the edge face and the end face. The resilient element is tensioned when the shaft falls by means of the edge face into the rolling bearing with the end face of the inner ring and supports the orientation of the inner ring in relation to the falling shaft. In order to receive the resilient element, the inner ring may have an angle relative to the rotation axis of the shaft, for example, an angle of 45°, and the edge face may project substantially perpendicularly relative to the rotation axis of the shaft so that a peripheral receiving space for the resilient element is provided.

Alternatively to an angular rolling bearing which can take up axial and radial forces to essentially the same extent, there is preferably provision for the rolling bearing to be constructed as a substantially axially acting ball bearing, with osculation of the bearing races of the balls at the outer ring of the rolling bearing increasing with increasing spacing from the rotation axis of the shaft. At the high rotary speeds which occur when the shaft is received in the back-up bearing, the increasing osculation at an increasing spacing from the rotation axis ensures that the rolling members are retained in the rolling bearing. In this instance, the inner ring can be constructed so as to be substantially planar.

Other advantages and features will be appreciated from the dependent claims and the following description of preferred embodiments of the invention.

### BRIEF DESCRIPTION OF THE DRAWINGS

The invention is described and explained in greater detail below with reference to the appended drawings.

FIG. 1 is a schematic cross-section through a first embodiment of a bearing arrangement according to the invention,

FIG. 2 is a schematic cross-section through a second embodiment of a bearing arrangement according to the invention, with the detail “X” being illustrated to a larger scale at the bottom right-hand side,

FIG. 3 is a portion of a cross-section through a third embodiment of a bearing arrangement according to the invention,

FIG. 4 is a portion of a cross-section through a fourth embodiment of a bearing arrangement according to the invention,

FIG. 5 is a portion of a cross-section through a fifth embodiment of a bearing arrangement according to the invention,

FIG. 6 is a portion of a cross-section through a sixth embodiment of a bearing arrangement according to the invention, and

FIG. 7 is a portion of a cross-section through a seventh embodiment of a bearing arrangement according to the invention.

FIG. 8 is a portion of a cross-section through an eighth embodiment of a bearing arrangement according to the invention.

### DETAILED DESCRIPTION OF THE PREFERRED EMBODIMENTS

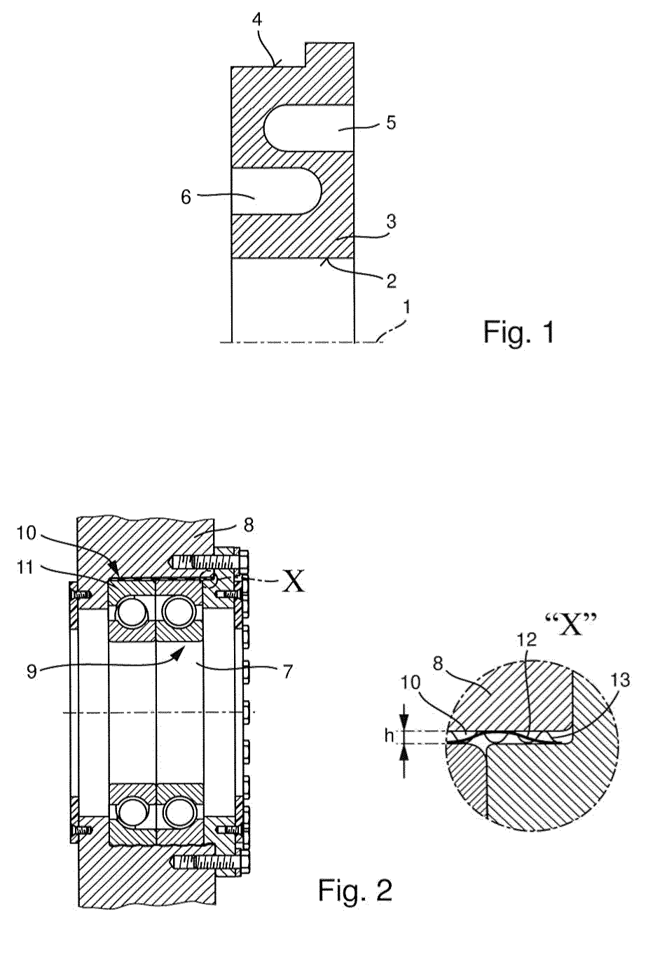

FIG. 1 shows a bearing arrangement, in which a shaft is supported rotatably about a rotation axis 1 by means of magnetic bearings. The bearing arrangement comprises at least one back-up bearing which is in the form of a rolling bearing, particularly a two-row angular ball bearing, and can take up forces both in an axial and in a radial direction. An outer ring of the rolling bearing is arranged on an inner face 2 of a bearing receiving member 3, which inner face is directed toward the rotation axis 1. The bearing receiving member 3 is arranged with an outer face 4 on a housing fixed in position. An inner ring of the rolling bearing is spaced apart from the outer face of the shaft by a back-up bearing gap as long as the shaft is supported in the magnetic bearings.

The bearing arrangement is part of the bearing of a shaft of a compressor rotating at rotary speeds of approximately 6000 rpm and being of solid construction. If the magnetic bearing fails, the shaft falls into the back-up bearing.

The rolling bearing is substantially free in a radial direction and can therefore take up forces in particular in an axial direction but can take up forces in a radial direction only to a limited extent and transmit them to the housing. The rolling bearing is therefore constructed so as to be rigid in an axial direction and so as to be resilient in a radial direction, perpendicularly to the extent of the rotation axis 1 of the shaft.

In order to arrange the rolling bearing so as to be substantially free in a radial direction, there is provision for the bearing receiving member 3, on which the outer ring of the rolling bearing is arranged, to have a material weakening, in particular two peripheral grooves 5, 6, which extend round the rotation axis 1. The first groove 5 is constructed at one side and the second groove at the opposite second side 6 of the bearing receiving member 3, in each case approximately three quarters of the extent of the bearing receiving member 3 in the direction of the rotation axis 1 is deep enough for the deep portions of the two grooves 5, 6 to overlap each other perpendicularly to the rotation axis 1 in the viewing direction. The grooves 5, 6 reduce the capability of the bearing receiving member 3 to transmit forces which occur axially parallel with the rotation axis 1 only to a small extent. However, the grooves 5, 6 substantially decrease the transmission of radially acting forces to the housing.

The embodiments described below describe additional possibilities, by which it is possible to make provision for the rolling bearing to be substantially free in a radial direction. The same reference numerals indicate the same features or features which are comparable in terms of their technical effect.

FIG. 2 shows a bearing arrangement for rotatably supporting a shaft 7 relative to a housing 8, comprising a back-up bearing 9 which is in the form of a rolling bearing, with the rolling bearing being able to take up forces in an axial and radial direction and in particular being in the form of an angular rolling bearing, especially a two-row angular ball bearing. So that the rolling bearing 9 is substantially free in a radial direction, there is provision for a corrugated strip gap 10 to be constructed so as to be radially enlarged in the outer ring 11 of the rolling bearing 9. The corrugated strip gap 10, as the inset in FIG. 2 shows to an enlarged scale, is increased in a radial direction perpendicularly relative to the rotation axis 1 and has a radial extent h, which is approximately three to four times the general extent h′.

There is provision, as an additional supplementary step so that the rolling bearing 9 is substantially free in a radial direction, for a corrugated strip 12 having reduced rigidity, in particular having a reduced number of corrugations w per section in the peripheral direction and/or having an increased corrugation amplitude, to be arranged in the corrugated strip gap 10 on the outer ring 11 of the rolling bearing 9. The corrugated strip 12 is constructed in the form of a thin metal sheet which extends round the rotation axis 1 of the shaft and has corrugations. In order to reduce the rigidity of the corrugated strip 12 with a comparable sheet metal thickness, there is provision for the amplitude h of the corrugations which corresponds to the extent of the corrugated strip gap 10 in the radial direction to be increased, and, furthermore, for the number of corrugations per section in the peripheral direction to be increased, for example by an integral factor of from approximately 3 to 5, in comparison with a comparative corrugated strip 13 with a comparable corrugation amplitude.

There may alternatively be provision for a corrugated strip to be constructed as a composite of two partial corrugated strips which are secured to each other, with either of the partial corrugated strips extending round the rotation axis 1 so that the composite comprising both partial corrugated strips has a level of rigidity which is reduced in relation to the two partial corrugated strips while maintaining the dimensions of the partial corrugated strips.

FIG. 4 shows a bearing arrangement having a shaft and a back-up bearing in the form of a rolling bearing 9, with the outer ring 11 of the rolling bearing 9 being secured to a first portion 14 of a bearing receiving member 3, with a second portion 15 of the bearing receiving member 3 being arranged between the first portion 14 of the bearing receiving member 3 and the housing and both portions 14, 15 of the bearing receiving member 3 being supported in a resilient manner on each other in a radial direction. In particular, a resilient element 16 is provided between the two portions 14, 15 and takes up forces in a radial direction and suppresses transmission of the radial forces from the first portion 14 to the second portion 15. The second portion 15 displaceably supported in the first portion 14, in particular the first portion 14 engages over the second portion 15 at the axially outer side so that axially acting forces can be transmitted between the two portions 14, 15.

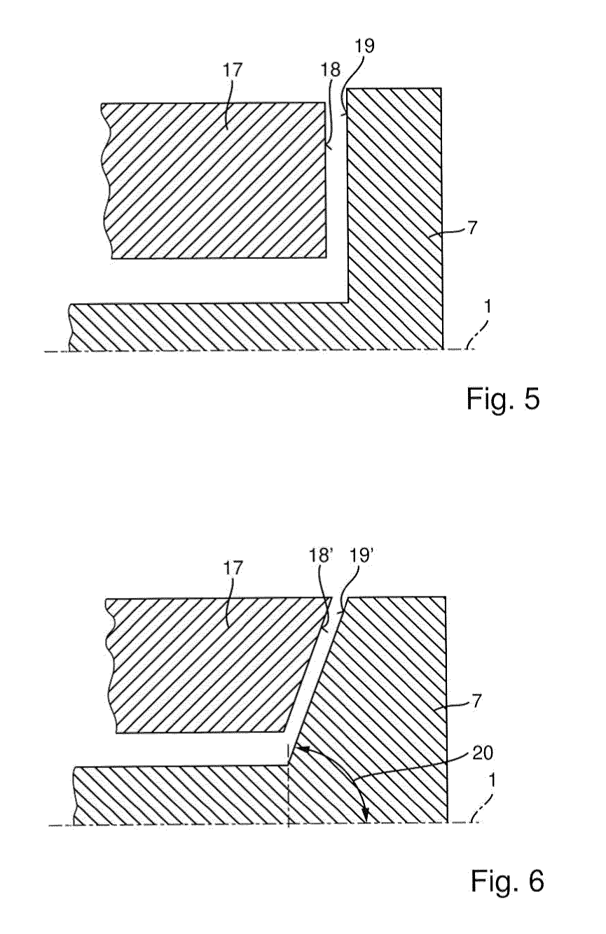

FIG. 5 shows a portion of an inner ring 17 of a back-up bearing for receiving a shaft 7, with an end face 18 of the inner ring 17 cooperating with a radially offset edge face 19 on the shaft 7 in order to orientate the inner ring 17 with respect to the shaft 7 in order to form a guiding face pair.

The end face 18 of the shaft 7 and the edge face 19 on the shaft 7 also form in particular a portion of a first friction face pair which with a second friction face pair, formed by the outer ring of the rolling bearing and an inner face of a bearing receiving member, with the friction properties of the two friction face pairs being adjusted for a friction-controlled self-centering action of the inner ring of the rolling bearing in relation to the shaft. There is particularly provision for a coating or a lining or a surface structure to be provided on the shaft 7, including in the region of the edge face 19, and on the end face 18 of the inner ring 17 and on the outer face of the inner ring 17 which comes into contact with the outer face of the shaft 7, or for the surface roughness to be adjusted so that the friction properties of the first friction face pair are increased in relation to the friction properties of the second friction face pair.

There is further provision for the friction properties of the second friction face pair to be reduced by coatings or reduced surface roughness levels. The various friction properties of the two friction face pairs support orientation of the inner ring 17 relative to the shaft 7.

FIG. 6 shows an embodiment which is modified in relation to FIG. 5 and in which there is provision for the edge face 19′ and the end face 18′ to be constructed in an inclined manner and to form a guide face pair. The end face 18′ and the edge face 19′ extend parallel and define with the rotation axis 1 a high angle 20 of between approximately 75° and approximately 85°. As a result of the inclined construction, the inner ring 17 is urged into a centered position when the shaft 7 falls into the back-up bearing with the edge face 19′.

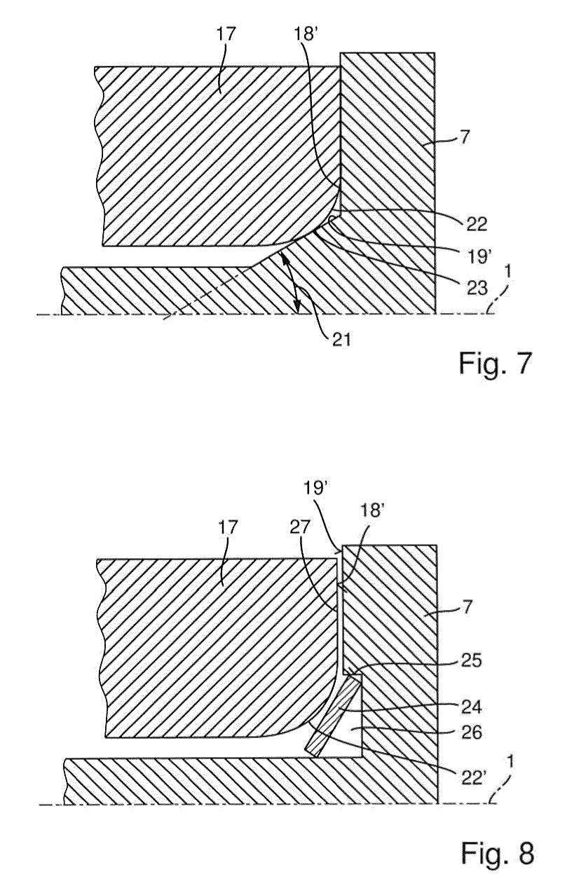

FIG. 7 shows an embodiment which is modified again in relation to FIG. 5 and FIG. 6. There is provision for the edge face 19′ to define partially an angle 21 of approximately 45° relative to the rotation axis 1 and wherein the end face 18′ has a rounded portion 22 which cooperates with the inclined portion of the edge face 19′.

The edge face 19′ has an inclined portion 23 which adjoins the outer face of the shaft 7 and which defines an angle of approximately 45° with the rotation axis 1. The inclined portion 23 of the edge face 19′ cooperates with a rounded portion 22 of the contour of the end face 18′ of the inner ring 17, with the rounded portion 22 being able to have a circular arc profile.

FIG. 8 shows an embodiment which is modified again in relation to the embodiments of FIGS. 5, 6 and 7, wherein there is provision for a resilient element 24 to be arranged between the edge face 19′ on the shaft 7 and the end face 18′ of the inner ring 17.

The edge face 19′ is substantially orientated perpendicularly to the rotation axis 1 and comprises a shoulder 25 which steps back in an axial direction so that a receiving space 26 is formed for the resilient element 24 which in particular can be in the form of a disk spring.

The end face 18′ of the inner ring 17 has a first portion 27 which is substantially perpendicular to the rotation axis 1 and a rounded portion 22′ which may have in particular a circular arc profile. The resilient element 24, that is to say, the disk spring, is arranged between the rounded portion 22′, the shoulder 25 at the edge face 19′ and the outer face of the shaft 7 in the receiving space 26, and is relaxed and tensioned in the normal operating state of the magnetic bearings when the shaft 7 falls into the back-up bearing, in particular when the shaft 7 approaches the inner ring 17 of the back-up bearing. The resilient element 24 tensions the inner ring 17 so that the inner ring 17 can take up a favorable centered position in relation to the shaft 7.

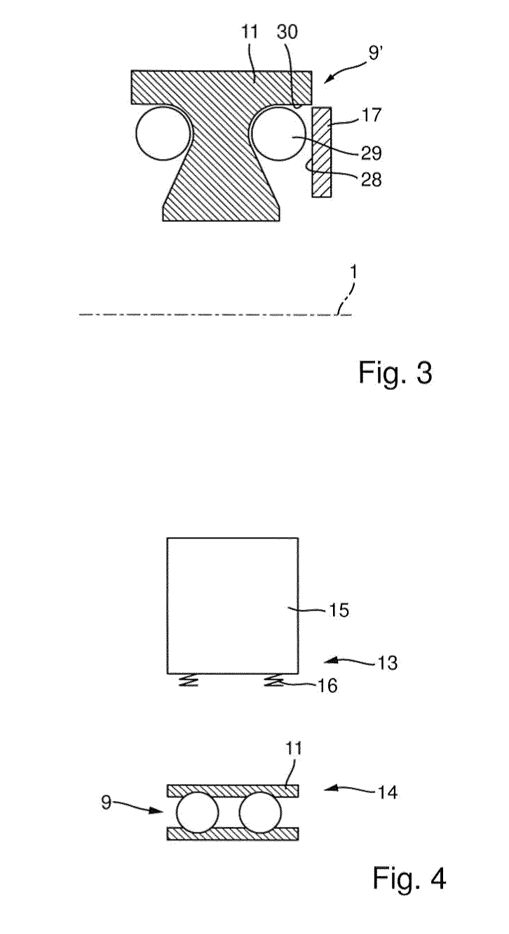

FIG. 3 shows an embodiment in which there is provision for the rolling bearing 9′ which is provided as a back-up bearing to be in the form of a substantially axially acting ball bearing an osculation of the ball races of the balls on the outer ring 11 of the rolling bearing 9′ increasing at an increasing spacing from the rotation axis 1 of the shaft.

The ball bearing 9′ takes up forces in a radial direction only to a limited extent and has a pressure angle which defines an angle of approximately 30° with the rotation axis. The inner ring of the ball bearing 9′ is in the form of a substantially planar disk and has a planar inner ring ball race 28 for the balls 29.

An outer ring ball race 30 on the outer ring 11 of the ball bearing 9′ has a profile in which an osculation of the ball race, that is to say the curvature radius of the ball race, depends on the spacing from the rotation axis 1. The osculation increases as the spacing from the rotation axis increases, with the result that the curvature radius likewise increases and the outer ring ball race 30 runs at a great spacing from the rotation axis 1 approximately parallel to the latter or is directed back towards the rotation axis 1. The inner ring 17 is displaceable substantially in a radial direction relative to the outer ring 11 so that the ball bearing 9′ can take up and transmit only forces in an axial direction.

### LIST OF REFERENCE NUMERALS

1 Rotation axis

2 Inner face

3 Bearing receiving member

4 Outer face

5 Groove

6 Groove

7 Shaft

8 Housing

9 Back-up bearing

10 Corrugated strip gap

11 Outer ring

12 Corrugated strip

13 Comparative corrugated strip

14 First portion of the bearing receiving member 3

15 Second portion of the bearing receiving member 3

16 Resilient element

17 Inner ring

18, 18′ End face

19, 19′ Edge face

20 Angle

21 Angle

22, 22′ Rounded portion

23 Inclined portion

24 Resilient element

25 Shoulder

26 Receiving space

27 Perpendicular portion

28 Inner ring ball race

29 Ball

30 Outer ring ball race

1. A bearing arrangement for rotatably supporting a shaft relative to a housing, comprising
a back-up bearing which comprises a rolling bearing, the rolling bearing takes up forces in an axial and radial direction and is an angular rolling bearing, and
the rolling bearing is substantially free to move in a radial direction.

2. The bearing arrangement as claimed in claim 1, further comprising a bearing receiving member on which an outer ring of the rolling bearing is arranged, the bearing receiving member has a peripheral material weakening.

3. The bearing arrangement as claimed in claim 1, wherein a corrugated strip gap is constructed on an outer ring of the rolling bearing that is radially enlargeable.

4. The bearing arrangement as claimed in claim 1, wherein a corrugated strip having reduced rigidity with at least one of a reduced number of corrugations per section in a peripheral direction or having an increased corrugation amplitude, is arranged on an outer ring of the rolling bearing.

5. The bearing arrangement as claimed in claim 1, wherein an outer ring of the rolling bearing is fixed to a first portion of a bearing receiving member, a second portion of the bearing receiving member is arranged between the first portion of the bearing receiving member and the housing, and the two portions of the bearing receiving member are resiliently supported on each other in a radial direction.

6. The bearing arrangement as claimed in claim 1, wherein an inner ring of the rolling bearing forms with the shaft a first friction face pair and an outer ring of the rolling bearing forms, with an inner face of a bearing receiving member, a second friction face pair, and friction properties of the two friction face pairs are adjusted for a friction-controlled self-centering action of the inner ring of the rolling bearing in relation to the shaft.

7. The bearing arrangement as claimed in claim 6, wherein the friction properties of the first friction face pair are increased by coatings, linings, surface roughness or surface structures in relation to the friction properties of the second friction face pair.

8. The bearing arrangement as claimed in claim 7, wherein the friction properties of the second friction face pair are reduced by coatings or reduced surface roughness.

9. The bearing arrangement as claimed in claim 1, wherein an end face of an inner ring of the rolling bearing cooperates with a radially offset edge face on the shaft.

10. The bearing arrangement as claimed in claim 9, wherein the edge face and the end face are formed so as to be at least partially inclined and form a guiding face pair.

11. The bearing arrangement as claimed in claim 10, wherein the edge face and the end face define an angle relative to a rotation axis of the shaft.

12. The bearing arrangement as claimed in claim 10, wherein the edge face partially defines an angle of approximately 45° relative to a rotation axis, and the end face has a rounded portion which cooperates with the inclined portion of the edge face.

13. The bearing arrangement as claimed in claim 10, wherein a resilient element is arranged between the edge face and the end face.

14. The bearing arrangement as claimed in claim 1, wherein the rolling bearing is constructed as a substantially axially acting ball bearing, an osculation of ball races of balls on an outer ring of the rolling bearing increases at an increasing spacing from a rotation axis of the shaft.

15. A bearing of a shaft of a compressor, comprising a bearing arrangement as claimed in claim 1.

16. The bearing arrangement as claimed in claim 2, wherein the peripheral weakening comprises two peripheral grooves.

17. The bearing arrangement as claimed in claim 11, wherein the angle is approximately 60° or greater.
